(19) United States
(12) Patent Application Publication
(10) Pub. No.: US 2013/0215203 A1
(43) Pub. Date: Aug. 22, 2013

(54) APPARATUS AND METHOD FOR PRINTING SHARP IMAGE IN AN INKJET PRINTER

(71) Applicant: Wen Chen, San Diego, CA (US)

(72) Inventor: Wen Chen, San Diego, CA (US)

(73) Assignee: Meijet Coating and Inks, Inc., Shanghai (CN)

(21) Appl. No.: 13/475,844

(22) Filed: May 18, 2012

(30) Foreign Application Priority Data
Feb. 17, 2012 (CN) 201210037578.5

(51) Int. Cl. B41J 2/01

(52) U.S. Cl. 347/102

(57) ABSTRACT

An apparatus and method to heat media in order to achieve rapid ink drying for sharp image quality is disclosed. The apparatus comprises a media heating means to heat media approximate the print zone to prevent coalescence and inter-color bleeding, and a printhead cooling means to cool the printhead so that the printhead temperature is maintained below an upper printhead temperature limit to minimize clogged nozzles. The preferred embodiment includes a hot air blower attached to the movable carriage to impinge heated air directly on to the media surface, and circulating a liquid coolant in a fluid channel built in a printhead plate conductively connected to the printhead.

### FIELD OF THE INVENTION

The present invention relates generally to inkjet printing, and more particularly to printing sharp images in an inkjet printer by heating the media and drying the ink thereon and cooling the printhead.

### BACKGROUND OF THE INVENTION

An inkjet printer typically includes a carriage holding a printhead thereon, a platen, and a print engine that has electronics including microchips to send out instructions for printing. The platen is coupled with a driving mechanism to transport media, i.e., the printing substrate, in a media movement direction. The printhead has small nozzles thereon that can eject out tiny ink droplets following instructions received from the print engine. The carriage is capable of traveling back and forth along a carriage scanning direction, which is typically perpendicular to the media movement direction. The combination of media movement and carriage movement ensures that ink droplets ejected from the printhead can land anywhere in a defined print area of the media to form an image.

When ink droplets land on the surface of the media, they form tiny ink dots to compose an image. Therefore the quality of the image formed is dependent on the quality of the ink dots, including size, shape, uniformity, opaqueness, and glossiness. While the size of the nozzles on the printhead is the primary factor for the dot size, ink dry time plays a significant role in determining the overall dot quality, and ultimate the image quality. It is preferred that ink dries fast on media so that the ink dots are quickly frozen to preserve their size, shape and other characteristics. In this way a sharp and crispy image can be obtained. When ink dries slowly on media, it remains at a liquid state for an extended period of time. The prolonged ink fluid ability and the ability for ink component to dissipate can cause image quality to degrade substantially, especially in an area where ink load is high. The edges of color patches can become soft, ragged and feathering. Inside color patches, color discontinuity can happen due to coalescence, which is local colorant concentration variation due to dissipation. When two patches of different colors share a boundary, slower than adequate dry time may cause inter-color bleeding, an undesirable image quality artifact.

Traditionally, proper ink dry time on media is achieved through manipulation of ink formulation or media structure, or both. The easiest solution comes from solvent ink, with ink vehicle composed mostly of high volatile solvents, such as ketones and glycol ethers. When ink droplets are ejected from the printhead and land on media, the volatile solvents quickly evaporates and ink on the media dries rapidly. Besides fast drying, aggressive solvents can dissolve into the media surface to create strong ink to media adhesion, hence excellent image quality and image durability. However, fume from the evaporated solvents usually has strong odor and is harmful to operators running the printers and pollutes to the environment.

Over the past years, milder and more environment-friendly solvent inks have been created in the inkjet printing industry, and so earned their names as eco-solvent ink, mild solvent ink, and etc. Nevertheless, ink vehicle of these types of inks consists mostly of solvents, maybe with higher boiling points and lower fume partial pressure. Since solvents of any type are not good for our health and unfriendly to environment, the genuinely healthy and environment-friendly ink has its ink vehicle based on water instead of solvents. This water based ink is called aqueous ink. Because water evaporates slower than high volatile solvents, to make the system work, a receptive layer is coated on the top surface of the media to quickly absorb moisture so that ink can dry fast after landing on the media. Another function of the receptive coating is to ensure that ink penetrates into it so that an ink to media bond is formed to achieve adequate durability and permanence. For optimal performance for aqueous ink, the receptive coating of a rapid dry media is usually composed of multiple layers. As such manufacturing of the rapid dry type of media is costly and energy intensive.

U.S. Pat. No. 7,241,003 B2, issued to Peter J. Fellingham et al on Jul. 10, 2007, discloses an ink drying system including a heated media support to heat up the media from the underside and a gas blower to blow air impinging on the top surface of the media so as to convectively remove moisture from the media. Therefore, lower grade media with fewer layers of coating can be used to print out decent quality images using aqueous ink. Or, images requiring heavy ink load can be printed on regular media without worrying about coalescence and bleeding. In this way operating cost is reduced and customers are happy. However, such a drying system does not support aqueous ink printing on uncoated media because the ink drying system is located downstream of the print zone. The time internal between printing and media dying causes perceivable image quality degradation due to coalescence and ink bleeding when uncoated media is used. In such a system, it is necessary to have an ink receptive coating on media, maybe a thin and simple one, to absorb moisture and to limit ink migration during the printing-to-drying interval.

It has long been desired in the art of inkjet printing to print images with aqueous ink on uncoated media. When achieved, such a system is genuinely healthy, friendly to environment, and also the cheapest to consumers. One way to achieve such a green and economical solution is to heat up the media to an elevated temperature immediately after the ink droplets land on the media to effectively dry the ink. U.S. Pat. No. 5,329,295, issued to Todd R. Medin et al on Jul. 12, 1994, teaches a media heater that heats the media from the underside at the print zone via radiant and convective heat transfer, with heat flux adjustable according to media type. However, in such a system heat transferred to the media inadvertently heats up the nozzles on the printhead that travels in the print zone for printing. The consequence is dried and clogged the nozzles. If aqueous ink is used for printing, more extensive nozzle maintenance is necessary, or image quality suffers.

U.S. Pat. No. 6,957,886 B2, issued to Dheya Alfekri et al. on Oct. 25, 2005, discloses an apparatus and method of thermal inkjet printing to print aqueous pigmented ink on non-porous, uncoated, untreated, and hydrophobic media. The ink contains an adequate amount of polymeric binder to adhere to the non-porous, uncoated, untreated, hydrophobic media. In the invention, the polymer content causes an ink viscosity that is higher than desired for proper ink drop ejection. Therefore, prior to jetting through the printhead nozzles, ink is heated to an elevated temperature to effectively lower viscosity for adequate jetting droplet quality. Additionally, the printing apparatus contains a first heater located upstream of the print zone to warm up and prepare the media for receiving the ink, and a second heater downstream of the print zone to warm up the media to a higher temperature to effectively dry the ink after the ink is deposited on the media. In practice, this type if printing system caused issues with printhead reliability and image quality. Ink heating prior to jetting and especially the heat dissipated from the pre-heated media to the nozzles on the printhead caused ink in the nozzles to dry and hence clogged nozzles.

As such, there is a need in inkjet printing to develop an apparatus and method to heat up the media at the print zone to effectively dry ink and meanwhile maintain nozzles from dried and clogged, in order to offer customer a solution to print aqueous ink directly on uncoated and untreated media for good image quality and durability.

### SUMMARY OF THE INVENTION

It is therefore an object of the invention to provide an apparatus and method in an inkjet printer to support printing aqueous ink that is healthy and environmental-friendly on uncoated and untreated media that has cost advantage. The apparatus comprises a media heating means to heat media proximate the print zone, as such ink droplets on the media is rapidly dried to prevent coalescence and inter-color bleeding. The apparatus also comprises a printhead cooling means to cool the printhead so that the printhead temperature is maintained below a upper printhead temperature limit.

According to one aspect of the invention, the media heating means comprises a hot air blower attached to the carriage traversing back and forth from-end-to-end of the printer along the print zone to cause hot air impinging onto the media to heat the media and to remove ink moisture.

According to another aspect of the invention, the media heating means further comprises a platen heater at or before the print zone.

According yet to another aspect of the invention, the printhead cooling means comprises a fluid channel running in a printhead plate conductively connected to the printhead, the fluid channel capable of circulating a liquid coolant to remove heat energy and to maintain the printhead temperature.

According to yet another aspect of the invention, the upper printhead temperature limit for maintaining optimal image quality is 40° C.

### BRIEF DESCRIPTION OF THE DRAWINGS

These and other objects and features of the invention will become more fully apparent from the following description and appended claims taken in conjunction with the following drawings, where like reference numbers indicate identical or functionally similar elements.

FIG. 1 is a partial perspective view of a wide format inkjet printer with the front cover removed to show the important components for image printing;

FIG. 2 is a perspective view of the media heater shown in FIG. 1 with half of the outer shell removed to reveal the internal components;

FIG. 3 is a cross-sectional view of the blowing nozzle plate on the media heater in FIG. 2;

FIG. 4 is a partial cross-sectional view to show a blocking plate installed on the media heater in FIG. 1 to block air flow from passing to the other side of the blocking plate in order to limit heat transfer to the printhead;

FIG. 5 is a view of the printhead plate in FIG. 1, holding two printheads with nozzles showing, and with internal fluid channels to circulate printhead coolant in order to cool down the printheads.

FIG. 6 is a schematic of a refrigerator attached to the printer body to remove heat energy from the printhead coolant after the coolant has circulated in the coolant channels in FIG. 5 for cooling down the printheads.

FIG. 7 is a perspective view of a cooling device comprising a heat sink with fins or pins attached to or grown from the printhead plate shown in FIG. 1 and a cooling fan attached to the heat sink to cool down the printheads held by the printhead plate. In the view direction nozzles on the printheads are at the hidden side of the printhead plate.

### DETAILED DESCRIPTION OF THE INVENTION

The present description will be directed in particular to elements forming part of, or cooperating more directly with, apparatus and methods in accordance with the present invention. It is to be understood that elements not specifically shown or described may take various forms well known to those skilled in the art.

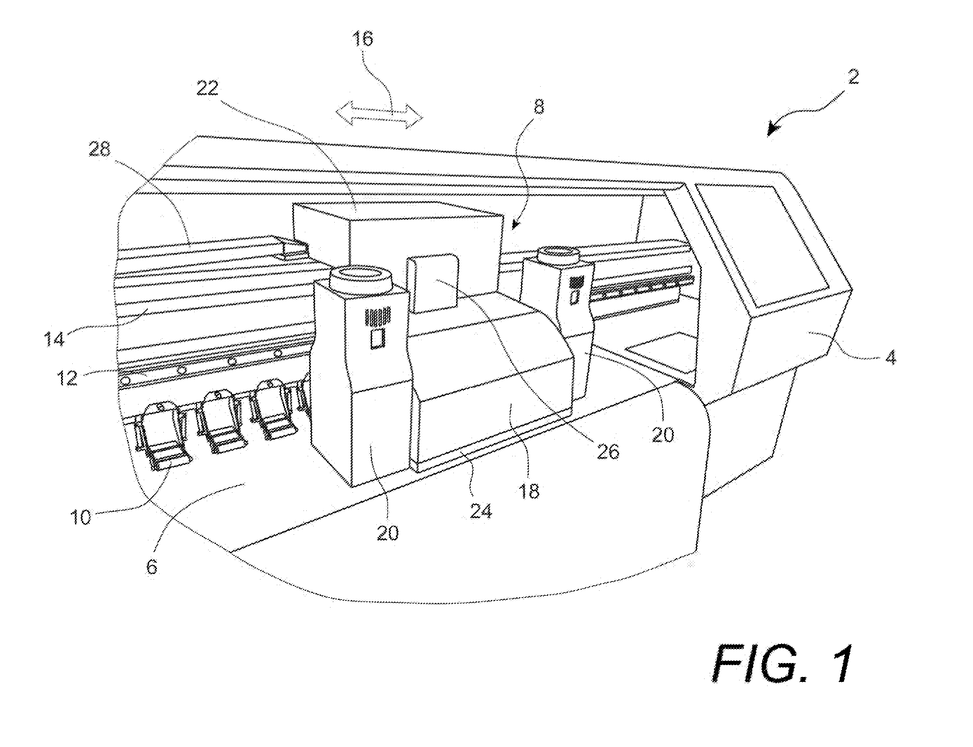

Referring to FIG. 1, an example of a wide format inkjet printer 2 is partially shown with the front cover removed to reveal the modules and components that are critical for printing an image. A wide format or large format inkjet printer is typically floor standing, and is capable of printing on media larger than A2 or wider than 17″. In contrast, a desk-top or an office printer typically prints on media sized up to 8.5″ by 11″ or 11″ by 17″, or the metric standard A4 or A3. Printer 2 has right side housing 4 and a left side housing (not shown) to enclose various electrical and mechanical components, including a main PC board (not shown) and ink supplies of different colors (not shown), and to carry features thereon for operator interface and printing control. Many of these components are related to the operation of the printer, but not directly pertinent to the present invention.

As shown in FIG. 1, printer 2 has platen 6 adapted to provide an essentially flat area to support a print media or substrate (not shown). Platen 6 is coupled with a media driving means (not shown), including at least one motor, gears, shafts and rollers, to transport media at precision in a media moving direction that is from the rear end to the front end of the printer. A row of spring loaded pinch rollers 10 are attached to the printer frame to press down the print media against a media drive roller (not shown) to move media forward or backward. Platen 6 has small holes distributed in the print zone that are channeled and connected to a vacuum source to cause suction to the underside of the media so that the media in the print zone provides a essentially flat area to receive ink during printing.

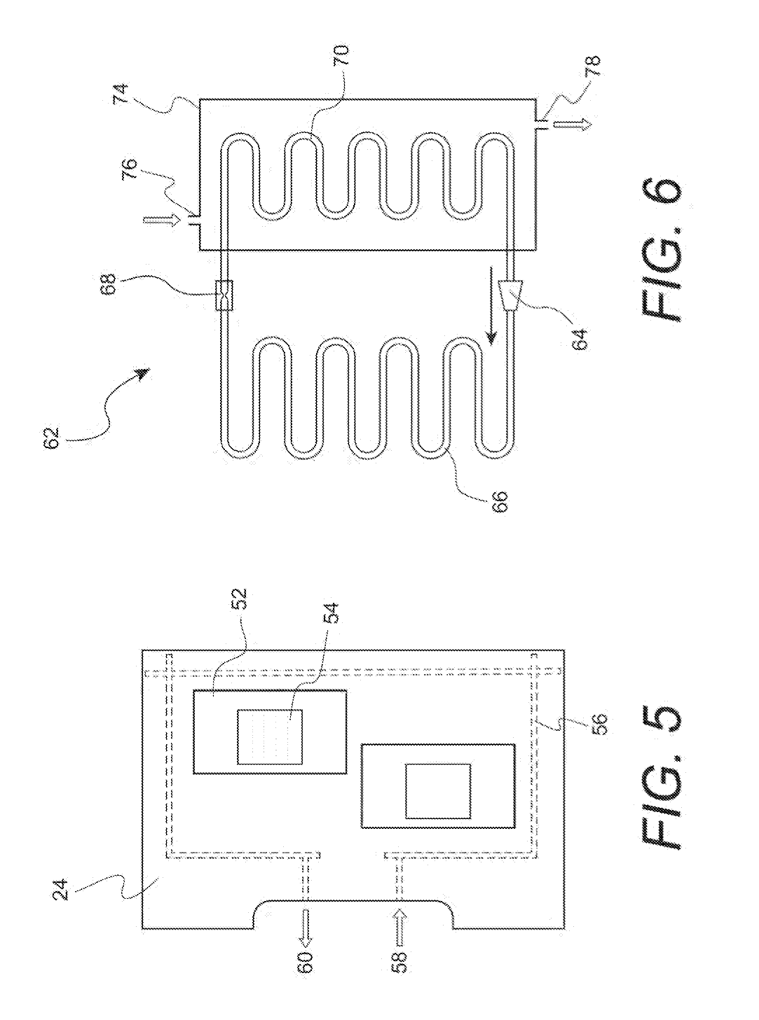

According to FIG. 1, carriage 8 rides on guiding rails 12 and 14, which can take different shapes such as shafts or bars, and bi-directionally traverses along scanning direction 16 from the left end to the right end of the printer. Carriage scanning direction 16 is essentially perpendicular to the media movement direction described in the previous paragraph. Carriage 8 comprises printhead module 18, media heater 20, and carriage electronics box 22. Printhead module 18 further comprises a printhead plate 24 that includes one or a plurality of printheads 52 (as shown in FIG. 5). And, printhead 52 has nozzles 54 thereon (FIG. 5) capable of ejecting tiny ink droplets to land on the media immediately underneath to form an image. As carriage 8 traverses from end to end of printer 2 carrying printhead 52 printing ink onto media over platen 6, a print zone on the platen is defined that is capable of receiving the ink from the printhead. Carriage electronics box 22 contains a carriage PC board capable of passing electrical signals to printheads in printhead module 18 through wires funneled in conduit 26 to control the printhead for printing.

Printhead 52 is typically from one of two types of technologies, thermal inkjet or piezoelectric inkjet. For thermal inkjet technology, a tiny electrical resistance heater, placed in a small fluid chamber, heats the ink in its proximity up to about 400° C., causing a small quantity of the ink to phase change into a steam bubble that raises the internal ink pressure sufficient for an ink droplet to be expelled out of a nozzle under the fluid chamber. For piezoelectric inkjet technology, an electric field is applied to a piezoelectric material possessing properties to create a mechanical strain in the material causing an ink droplet to be expelled. Lack of heat source to heat the ink and cause phase change, the piezoelectric inkjet typically imposes less restriction on ink formulation.

When a printing job is sent from a remote computer (not shown) to printer 2 to print out an image, the main PC board that is stationarily attached to the printer body, preferably inside the left side or right side housing of the printer, compiles the image data from the remote computer into printer level instructions, including power and data signals, and sends the signals to the carriage PC board residing in carriage electronics box 22, through flexible trailing cables carried inside flexible chain 28 which has an internal space along its length direction to house and protect components such as electrical flexible trailing cable and ink tubing. The electrical power and data signals are further compiled at the carriage PC board in carriage electronics box 22 to produce series of electrical pulses. And the electrical pulses are delivered to printheads 52 attached on printhead module 18 through electrical wires in conduit 26 to cause inkjet droplets to be selectively ejected out of nozzles 54 on printheads 52 following timing signals generated by a encoder reader (not shown) attached to carriage 8. Meanwhile carriage 8 moves along carriage scanning direction 16, and media is transported by the media driving means in the media movement direction, as such the ink droplets ejected from nozzles 54 can land on predetermined locations on the top surface of the media to form an image according to the print job sent from the computer. Preferably, inks of 4 colors, including cyan, magenta, yellow and black, or more are used for image printing. As ink droplets are dispensed from nozzles 54, inks in the printheads are replenished from ink supplies stationarily attached to the printer body through flexible ink tubing running through the internal space of flexible chain 28 and conduit 26 to reach the printheads.

Back to FIG. 1, media heater 20 rides on carriage 8 to heat media in the print zone so as to dry the ink droplets immediately after the droplets landed. In this way, ink coalescence and inter-color bleeding can be effectively prevented and good image quality achieved.

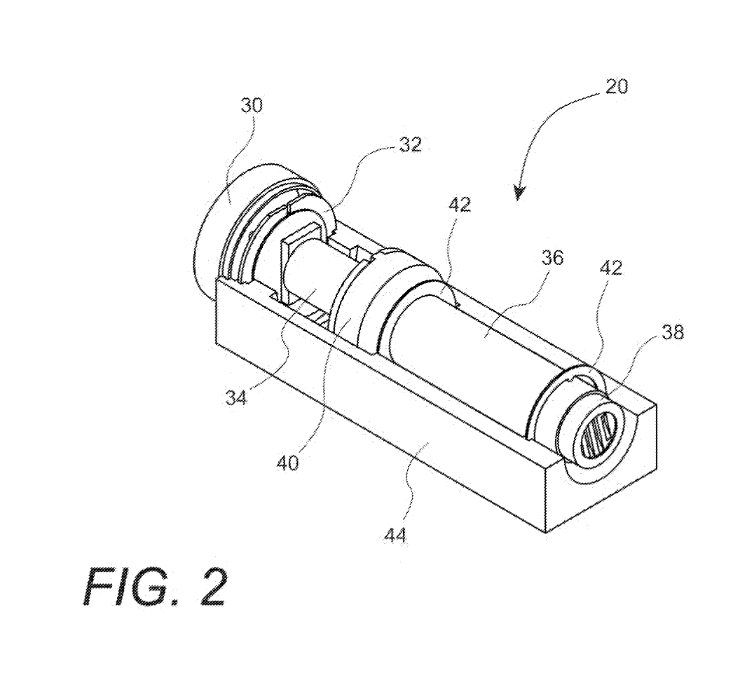

FIG. 2 depicts a hot air blower as a preferred embodiment of media heater 20 shown in FIG. 1. The hot air blower comprises top cover 30, media heater PC board 32, fan module 34, heater module 36, and blowing nozzle plate 38. All of the components are tightly held in place in two halves of clam shells 44, which provide feature to assemble to movable carriage 8. In FIG. 2 the top half of the clam shells is removed and the components revealed. Fan module 34 is tightly held in place by fan module holder 40 to reduce vibration and to eliminate rattling; and heater module 36 is positioned with the help of holding rings 42, leaving an air gap to thermally insulate the heater module from the outer clam shell. Preferably the housing of heater module 36 is made of a material having low thermal conductivity, such as certain types of polymer plastics, to reduce heat loss due to conduction heat transfer. The heating element contained in heater module 36 can be an electrical resistance heater such as a nichrome wire coil, or a ceramic heater. Relying on IR radiation to transfer heat, a ceramic heater possesses the advantage of rapid and uniform heating.

The hot air blower shown in FIG. 2 has advantage of effectively remote moisture and dry ink on media. The convection caused by the hot blowing air has two aspects, heat transfer and mass transfer. Media heater PC board 32 controls the fan power for desired blowing air flow rate and the heater power for desired blowing air temperature according to instructions generated from the main PC board. The flow rate and air temperature can be optimized to achieve the best results of removing moisture and drying ink.

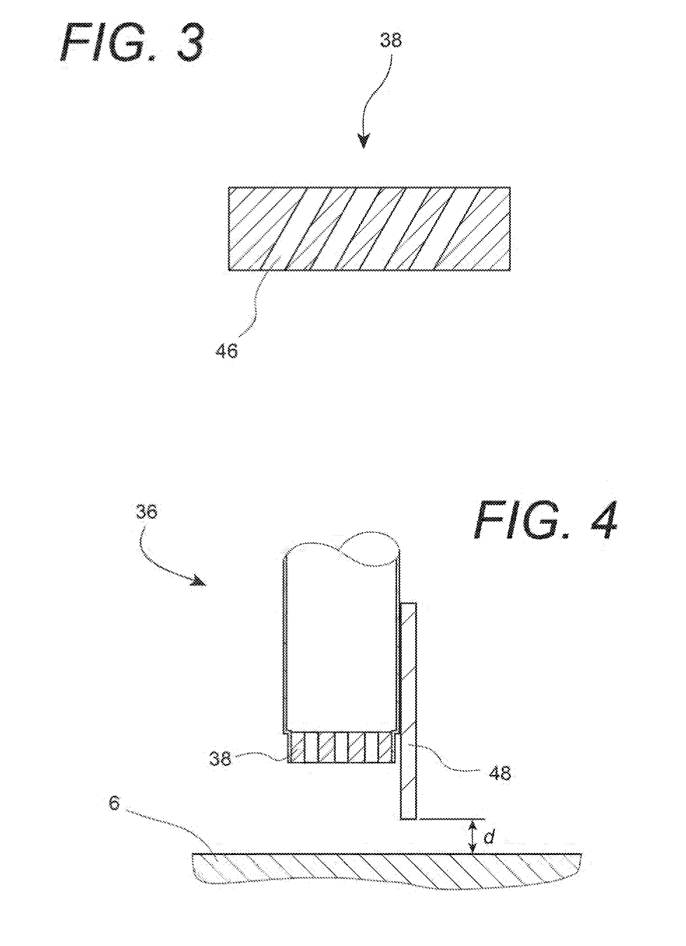

FIG. 3 depicts a cross-sectional view of blowing nozzle plate 38 of the hot air blower in FIG. 2. Slot blowing nozzles 46 are slanted, guiding hot air from media heater 20 to form a unidirectional flow on media. When media heater 20 is assembled to the carriage, blowing nozzles 46 are orientated so that the heated air flows away from printhead module 18. In the setup depicted in FIG. 1, hot air from media heater 20 attached to the left side of printhead module 18 is guided to flow toward the left end side of the printer, and hot air from media heater 20 attached to the right side of printhead model 18 is guided to flow toward the right end side. Another embodiment to guide hot air flow is shown in FIG. 4, where blocking plate 48 is installed between media heater 20 and printhead module 18. Further, media heater 20 is assembled to the carriage in a way to leave a gap between blowing nozzle plate 38 and platen 6 that is substantially larger than distance d shown in FIG. 4. Therefore, when hot air is blown out of blowing nozzles 46 of media heater 20, the air is blocked by blocking plate 48 and is forced to flow in the direction away from printhead module 18. An alternative of the implementation in FIG. 4 is to make blowing nozzle plate 38 and blocking plate 48 in one piece so that the design is simplified.

Media heater 20 can be arranged on movable carriage 8 in different manners. As shown in FIG. 1, two media heaters are assembled, one on the left side of printhead module 18, and the other on the right side. This arrangement allows even sequencing and uniform heat distribution for bi-directional printing, because for printing both left-to-right and right-to-left there is a leading heater and a trailing heater for the printing swath. For unidirectional printing, however, the two media heaters arrangement only has the advantage of double heating power. A second arrangement is to assemble one media heater 20, instead of two, either to the left side or to the right side of printhead module 18. In this way, heating sequence and distribution for bidirectional printing is not as ideal as the previous arrangement. But the width of carriage 8 can be made shorter, and so is the width of printer 2. Shorter printer width saves printer cost and the standing space for printing operation. A third arrangement is to place one or a plurality of media heaters 20 at the front side of carriage 8, opposite to the side that carriage 8 is slidably attached to guiding rails 12 and 14. This third arrangement can result in the shortest carriage width and therefore the shortest printer width. However, there is a short time delay between printing ink droplets on media and heating of the ink droplets because the media heater is located slightly away from the print zone. And the short time delay may compromise image quality depending on the ink and media type in use.

FIG. 2 merely shows one embodiment of media heater 20 as part of movable carriage 8. There exist many other implementations, including different heat sources and heating methods, to achieve essentially the same purpose of heating media and drying ink printed thereon. For example media heater 20 can be a microwave heater that radiates microwave energy to the media surface.

Also, attaching media heater 20 to movable carriage 8 is merely one of many ways to heat media and dry ink thereon. One of ordinary skill in the art can apply other means to use different heat sources, methods and implementations. For example, one or a plurality of IR bulbs can be buried in platen 6 at or before the print zone covering the whole media width, emitting IR radiation to heat media from the underside through openings or a layer transparent to IR spectrum. Another embodiment has an electrical resistance heater, such as a flexible tape heater or a wire heater, conductively attached to the internal structure of platen 6 at or before the print zone to heat media through conduction. For this embodiment, it is preferred that the platen material, at least at the print zone or where heat is applied, has high thermal conductivity. Such a material can be aluminum or copper, for example. To achieve the result of heating media to a higher temperature, combinations of heating methods can be used. For example, a platen heater can be used to conductively heat the media from the underside through platen 6 at or immediately before the print zone. And a hot air blower attached to carriage 8, as shown in FIG. 1, impinges hot air onto the top surface of the media in the print zone to further convectively heat the media.

When media is heated in the print zone, ink droplets start to dry immediately after landing on the media. Ink dry time is dependent on the heating power of media heater 20. The faster the dry time, the faster the ink droplets to freeze their size, shape and other dot characteristics. And, hence better image quality can be achieved. As such, customers can use aqueous ink and cheaper media that has less coating for better health, environment protection and less operation cost. The best ink and media combination is aqueous ink on uncoated and untreated media. Higher media temperature in the print zone of course leads to faster dry time. But higher media temperature inevitably consumes more heating energy. Therefore ink formulation and media heating means in printer need optimization so that printing aqueous ink on uncoated and untreated media can happen at a temperature range that is not too high, i.e., below an upper media temperature limit. For one preferred solution, ink formulation includes a significant amount of water, for example, greater than 40% by weight, certain co-solvents, and a small amount of polymeric binder for ink to media adhesion. Customers can choose from a wide varieties of coated or uncoated, untreated media, for example, plastic based media such as vinyl, paper based media, fabric based media, laminated foam board, metal plate, and glass plate, etc. And the heating apparatus in printer heats the media in the print zone to a temperature range that is below an upper limit of 90° C. For the aqueous ink described above, it is preferred to have a post printing baking process to heat the media to a higher temperature in order to fuse the polymeric binder onto the media surface for the best image durability. The baking process can be a second media heater downstream of the print zone. Or, it can be a process on a separate apparatus after the printing job is done.

Media heating in the print zone, especially when the heating flux is high for rapid ink drying, inevitably causes printhead to heat up even with the best insulation and hot air flow guiding arrangements, such as those shown in FIGS. 3 and 4. Printhead 52 is typically 1-2 mm away from the top surface of media. At such a close proximity, heat from the media is transferred to printhead 52 through convection and radiation. Higher media temperature in the print zone therefore causes printhead temperature to go higher. Thus ink in nozzles 54 evaporates and dries at a faster speed and clogged nozzles can happen. The easiest solution to counter the nozzle drying issue is to add more high boiling point and low volatile solvents in the ink to reduce evaporation. Nevertheless, as solvent content goes higher, the ink becomes less healthy and environment friendly. Another solution is to increase the frequency and intensity of nozzle cleaning servicing, including spitting ink droplets from nozzles, vacuum priming, wiping, and etc. This solution will affect productivity and waste more ink, and may not work when printhead temperature is too high.

When ink contains a significant amount of water as its vehicle, it is preferred to maintain the printhead temperature below an upper limit to achieve optimal nozzle performance. At room temperature, the dried ink is quickly dissolved by the ink vehicle in the nozzles, and nozzles 54 will stay unclogged and alive. Above certain printhead temperature, though, ink drying in the nozzles cannot be quickly dissolved, and the consequence is clogged nozzles that lead to poor image quality. For the ink, media and media heating combination in this invention, the upper printhead temperature limit is 40° C.

A first order improvement for printhead temperature control is to include an insulation layer between media heater 20 and printhead module 18. When media heating power is high to dry high load aqueous ink on uncoated media, for example, advanced method needs to be adopted. FIG. 5 shows an embodiment for printhead temperature control by circulating a liquid coolant in a conductive printhead plate 24 that is in contact with printhead 52. Printhead plate 24 is made of a material having high thermal conductivity. To effectively dissipate heat out of printhead 52, a large contact area between printhead plate 24 and printhead 52 is needed. In FIG. 5, printhead plate 24 is implemented in such a way to embrace the perimeter printhead 52 for maximal contact area. Conductive adhesive can be applied to the interface between printhead plate 24 and printhead 52 to further increase conduction heat transfer. A fluid channel 56 is built inside printhead plate 24 to circulate the coolant to cool down the plate, and consequently maintain the temperature of printhead 52. Fluid channel 56 can be drilled in a solid piece of printhead plate, or it can be formed by sandwiching two thinner plates together.

FIG. 6 reveals an embodiment to maintain printhead coolant temperature by a refrigeration means located off movable carriage 8 and attached to the printer body. The refrigeration coolant for the refrigeration means goes through compressor 64 to be compressed to a higher pressure and an elevated temperature, condenser 66 to cool down and get condensed to liquid state, then expansion valve 68 to reduce pressure and to a lower temperature. After that the refrigeration coolant enters into the printhead coolant supply container 74 and runs through evaporator 70 to absorb heat from the printhead coolant that enters into printhead coolant container 74 at inlet 76 and leaves the container at outlet 78.

The printhead coolant in supply container 74 is pumped through a first flexible tubing running inside flexible chain 28 and carriage conduit 26 to reach printhead plate 24, entering fluid channel 56 from coolant inlet 58. After circulation in fluid channel 56, the coolant leaves printhead plate 24 from coolant outlet 60, returning to the off-carriage coolant supply container 74 through a second flexible tubing running inside carriage conduit 26 and then flexible chain 26.

Many other methods can be appreciated by one of ordinary skill in the art to cool down the printhead coolant off movable carriage 8. For example, a heat sink with forced convection from a fan is one method. And, a heat exchanger represents another. One alternative embodiment for cooling down the printhead coolant in FIG. 5 is to pump the coolant from coolant outlet 60 to a finned or pinned heat sink positioned on carriage 8, for example, on top of carriage electronics box 22, and to cool the heat sink with the wind caused by the moving carriage, or by a fan attached to and blowing against the heat sink. Another alternative is to select a coolant that can evaporate and condensate in the operation temperature range and to allow the coolant to go through a refrigeration cycle in order to bring heat out of the printhead. That is, the coolant evaporates at the printhead to absorb heat, then is compressed to cause the coolant temperature to rise, followed by condensation located away from the printhead where heat is transferred to the environment. Before going back to the printhead, the coolant goes through an expansion valve to reduce pressure and temperature.

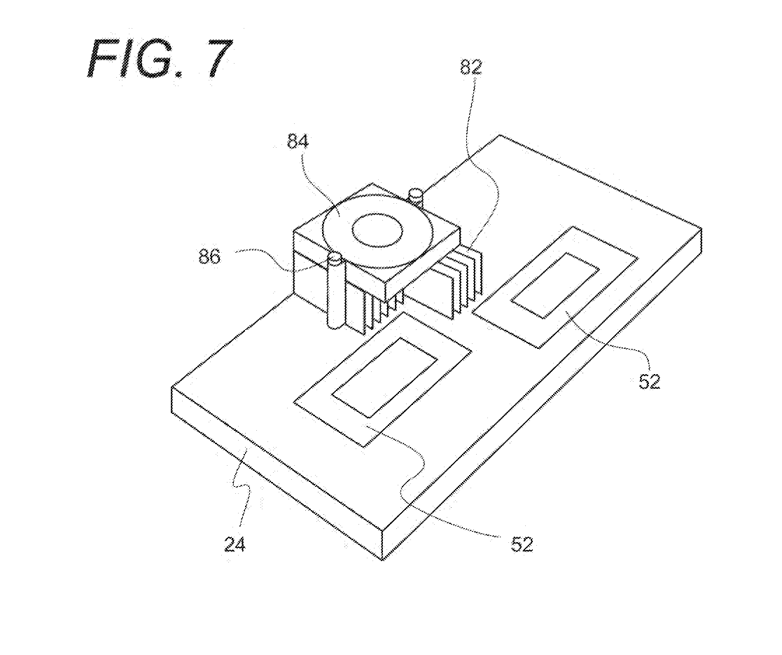

Another embodiment for printhead temperature control is depicted in FIG. 7 where heat sink 82 with fins or pins is formed on or attached to printhead plate 24 to extend the cooling surface and fan 64 is attached to heat sink 82 by fasteners 86 to cause forced convection to cool printhead plate 24 and ultimate the printhead 52. The cooling effectiveness can be optimized by the fin or pin structure design of the heat sink and the fan power.

It is understood that the above-described invention is merely illustrative of the possible specific embodiments which may represent principles of the present invention. Other arrangements may readily be devised in accordance with these principles by those skilled in the art without departing from the scope and spirit of the invention.

1. An apparatus in an inkjet printer capable of drying ink on a media wherein the media is loaded and moved on a platen in the inkjet printer, comprising:
a movable carriage holding a printhead thereon for ejecting ink droplets onto the media to form an image, wherein the carriage is adjacent the platen and traverses in a carriage scanning direction along a print zone on the platen;
means for heating the media to a preferred media temperature range to dry the ink droplets thereon proximate the print zone; and
means for cooling the printhead so that the printhead temperature is below an upper printhead temperature limit.

2. An apparatus as recited in claim 1 wherein:
means for heating the media comprises a hot air blower attached to the movable carriage to blow heated air impinging on the top surface of the media; and
wherein the hot air blower includes a heating element and a fan adapted to flow air passing the heating element.

3. An apparatus as recited in claim 2 wherein:
means for heating the media further comprises a platen heater proximate the print zone to heat the media from the underside.

4. An apparatus as recited in claim 2 wherein:
the hot air blower is located at one end of the movable carriage, extending the carriage along the carriage scanning direction.

5. An apparatus as recited in claim 2 wherein:
the hot air blower is located at both ends of the movable carriage, extending the carriage along the carriage scanning direction.

6. An apparatus as recited in claim 2 wherein:
the hot air blower is located at the front side of the movable carriage, opposing the side where the carriage is slidably attached to the printer frame.

7. An apparatus as recited in claim 2 wherein:
the hot air blower comprises an air delivery structure to guide heated air to flow away from the printhead.

8. An apparatus as recited in claim 1 wherein:
means for cooling the printhead comprises a fluid channel in a printhead plate conductively connected to the printhead in the movable carriage, the fluid channel capable of circulating a coolant.

9. An apparatus as recited in claim 8 wherein:
the coolant is pumped from a coolant supply attached to the printer body and through flexible tubing to the movable carriage.

10. An apparatus as recited in claim 9 wherein:
the coolant supply is connected to a refrigerator to cool down the coolant.

11. An apparatus as recited in claim 8 wherein:
the coolant is pumped from a cooling device attached to the movable carriage to the printhead plate, the cooling device cooling down the coolant by a heat sink.

12. An apparatus as recited in claim 1 wherein:
the preferred media temperature range is below an upper limit of 90° C.

13. An apparatus as recited in claim 1 wherein:
the upper printhead temperature limit is 40° C.

14. An apparatus in an inkjet printer capable of drying ink on a media wherein the printer has a platen to support and move the media thereon, a movable carriage is slidably attached to the printer frame and traverses in a carriage scanning direction along the platen, and the movable carriage holds a printhead thereon for ejecting ink drops on the media to form an image, comprising:
a hot air blower attached to an end of the movable carriage, the hot air blower capable of delivering hot air impinging onto the media to heat media to a preferred media temperature range to dry the ink drops thereon, the hot air blower including an air delivery structure to guide the air flow away from the printhead; and
a printhead plate conductively attached to the printhead in the movable carriage, the printhead plate including a fluid channel capable of circulating a coolant to maintain the temperature of the printhead below an upper printhead temperature limit.

15. An apparatus as recited in claim 14, further comprising:
a platen heater attached to the platen proximate the print zone to heat the media from the underside.

16. An apparatus as recited in claim 14 wherein:
the coolant is supplied by a pump through flexible tubing from a coolant supply attached to the printer body, the coolant in the coolant supply being cooled by an refrigerator.

17. An apparatus as recited in claim 14 wherein:
the coolant is supplied by a pump through flexible tubing from a cooling device attached to the movable carriage, the coolant in the cooling device being cooled by an heat sink.

18. A method of printing a sharp image on a media loaded in an inkjet printer wherein the printer has a platen adapted to support and move the media thereon, a movable carriage is slidably attached to the printer frame and traverses in a carriage scanning direction along the platen, and the movable carriage holds a printhead thereon for ejecting ink droplets onto the media to form an image, comprising the steps of:
heating the media proximately in the print zone so that the ink droplets are set immediately after landing on the media; and
cooling the printhead by circulating a coolant in a printhead plate conductively attached to the printhead.

19. An method as recited in claim 18, wherein:
the step of heating the media comprises heating the media by a hot air blowing device attached to an end of the movable carriage, the hot air blowing device capable of delivering hot air impinging onto the media to dry the ink droplets thereon, the hot air blowing device including an air delivery structure to direct the air flow away from the printhead.

20. An method as recited in claim 18, wherein:
the step of heating the media comprises heating the media by a electrical resistance heater attached to the platen proximate the print zone;
wherein the platen is made of a material having high thermal conductivity; and
whereby heat is transferred from the electrical resistance heater through the platen to the media primarily by conduction.
